(19) United States
(12) Patent Application Publication
(10) Pub. No.: US 2010/0062162 A1
(43) Pub. Date: Mar. 11, 2010

(54) Method for Strengthening Metal Articles and Parts

(76) Inventors: Irina Nikolayevna SHABANOVA, Izhevsk (RU); Viktor Aleksandrovich TRAPEZNIKOV, Izhevsk (RU); Vitaly Anatolevich ZHURAVLEV, Izhevsk (RU); Lyudmila Viktorovna ZHURAVLEVA, Izhevsk (RU)

Correspondence Address: Aleksandr Smushkovich, Post Office Box 140505, Brooklyn, NY, 11214, US

(21) Appl. No.: 11/991,496

(22) PCT Filed: Apr. 3, 2006
(86) PCT No.: PCT/RU2006/000157

§ 371 Date: Mar. 5, 2008

(30) Foreign Application Priority Data
Sep. 16, 2005 (RU) 2005129009

(51) Int. Cl. B05D 5/00

(52) U.S. Cl. 427/258

(57) ABSTRACT

The present invention allows enhancing durability and wear resistance of metal articles used in various constructions with high-strength requirements. The inventive method comprises applying a strengthening layer made of material exhibiting heavy-fermion properties in the form of a cerium heavy-fermion compound. Such compound has a covalence degree in the atom chemical bond ranging from 0.3 to 0.7, and energy bands gap of 0<ΔE<3 eV. Particularly, the compounds include cerium with at least one element of IIIA-VIA groups of the Periodical System, and/or at least one transition metal provided with a filled or close to be filled d-shell. A layer of crystalline material, that readily becomes amorphous, is optionally applied over the strengthening layer for its protection. The invention enables strengthening metal articles exposed to critical mechanical and thermal loads in 10 and more times and enables operating the articles under conditions that otherwise would cause breaking of the articles.

### CROSS-REFERENCE TO RELATED APPLICATIONS

This application is a U.S. national phase application of a PCT application PCT/RU2006/000157 filed on 3 Apr. 2006, published as WO2007/032702, whose disclosure is incorporated herein in its entirety by reference, which PCT application claims priority of a Russian patent application RU2005/129009 filed on 16 Sep. 2005.

### FIELD OF THE INVENTION

The present invention relates to methods for enhancing durability, and wear resistance of metal articles and parts, which are used in aircraft construction, mechanical engineering, machine-tool construction and tool-making, with high strength requirements.

### BACKGROUND OF THE INVENTION

The objective of the invention is to enhance durability and wear resistance of metal articles and parts exposed to high mechanical and thermal loads and operating under conditions that can cause corrosion or erosion of the metal articles' and parts' surfaces. Examples of such metal articles and parts functioning under the aforesaid conditions are blades of compressors and turbines of aircraft engines, cylinders and rings of internal combustion engines, gun barrels, component parts of grinding and metal-processing machines such as milling tools, rams, lathe bits, cutting tools, etc. The necessity of strengthening of the surfaces of these tools derives from the fact that under severe operational conditions, microscopic cracks and cavities, formed on the surface of the metal articles and parts, cause destruction or damage of the metal articles and parts and decreasing their service life.

The use of rare-earth metals and their compounds including cerium and its compounds is known for improving strength characteristics of metal parts. Cerium and its compounds are known to be added into alloys or used for protective coatings. For coating with cerium-containing materials, different methods are used such as electrolytic deposition (U.S. Pat. No. 5,932,083, Cl.205/261, 1999, U.S. patent application No. 2004/0144642, Cl.204/290.04, 2004), electroplating (EP No. 1354970, Cl.C22C38/00. etc., 2003), vacuum deposition, gas- and vapor-phase deposition (U.S. Pat. No. 6,808,761 Cl.427/596, 2004 r., U.S. patent application No. 2004/0026260, Cl.205/261, 2004), plasma spraying (EP No. 1260602, Cl.C23C4/12, 2002, etc.), ion implantation (RF patent No. 2235147, Cl.C23C14/48, 2004). The present invention provides a method that allows obtaining good technical results in improving wear resistance of articles, when any known technology for coating deposition, available to manufactures is used (at present, the ion implantation method is unavailable to most manufacturers).

The choice of one or another cerium-containing material is determined by the intended use of an article, the conditions of its functioning, service life requirements, etc. Thus, cerium oxides, oxalates and dioxides are used for enhancing corrosion and erosion resistance (U.S. Pat. No. 5,932,083, Cl.205/261, 1999, U.S. patent application No. 2004/0020568, Cl.148/273, 2004, U.S. patent application No. 2004/0016910, Cl.252/387, 2004, U.S. patent application No. 2004/0028820, Cl.427/367.1, 2004), improving abrasive properties of articles and polishing tool quality (Jap. patent application No. 2000117643, Cl.B24D3/32, 2000, U.S. Pat. No. 6,471,733, Cl.51/298, 2002), improving hardness and high-temperature stability and for preventing the formation of cracks (Jap. patent No. 2001302943, Cl.C09C3/08, etc., 2001, WO No. 0153420, Cl.C08F290/00, 2001). For enhancing breaking strength of cutting tools, cerium fluorite is used (Jap. patent application No. 2003321763, Cl.C23C 14/06, 2003). The use of cerium and its salts is known for coatings enhancing breaking strength of articles produced from different metals and alloys including aluminum and its alloys (U.S. Pat. No. 6,077,885, Cl.523/445, 2000, U.S. Pat. No. 6,248,184, Cl.148/275, 2001, U.S. Pat. No. 6,635,362, Cl.428/678, 2003).

U.S. patent application No. 2002/0132131 (Cl.428/615, 2002) is considered the closest piece of prior art (herein called ‘prototype method’), which is based on the formation of an amorphous strengthening layer containing cerium oxide on the article surface.

The disadvantage of the prototype method, as well as of all the above-mentioned methods, is insufficient strength of the strengthening layer, which is expressed in the fact that the exploitation life-time of articles produced with the use of that method increases no more than twice.

### BRIEF DESCRIPTION OF THE INVENTION

The method claimed in the present invention, like the prototype method, is based on the formation of the strengthening layer from cerium heavy-fermion compound under an impulse action.

As cerium heavy-fermion compounds, it is practical to use cerium compounds which have an electronic system relaxation time in the range from 10⁻⁴ to several seconds after exposure to the impulse action.

As cerium heavy-fermion compounds, it is practical to use cerium compounds, which have a covalence degree in atomic chemical bond in the range from 0.3 to 0.7, and an energy bands gap of 0<ΔE<3 eV.

In this case, cerium compounds containing an element from IIIA-VIA groups of the Periodic Table or transition metals with a filled d-shell or a d-shell close to being filled in their composition are used as cerium heavy-fermion compounds.

The thickness of the strengthening layer being formed is not less than 1 μm. It is practical to form the strengthening layer thickness in several steps. In this case, at each step of the strengthening layer formation, different materials are used depending on the functioning conditions of an article.

After an article has been coated with the strengthening layer, it is practical to deposit a layer from crystalline amorphized material upon it. The invention is based on experimental research, and the research results are theoretically grounded.

The research shows that the strengthening layer based on the material in the heavy-fermion state allows increasing wear resistance of articles by a factor of tens. A characteristic feature of heavy-fermion systems is high density of electrons at the Fermi level and large effective mass of conduction electrons. The heavy-fermion state of cerium-containing materials based on cerium compounds is associated with the presence of f-electrons in them. An external action upon these materials leads to filling a localized f-shell in them due to cerium valence electrons and/or other components contained in the compound composition, and as a consequence, to an increase in the density of electrons at the Fermi level and to the growth of inter-atomic interaction.

At external actions, heavy-fermion properties are characteristic of cerium compounds containing elements from IIIA-VIA groups of the Periodic Table, cerium compounds containing, at least, one transition metal with a filled d-shell or a d-shell close to being filled in their composition (Cu, Ag, Au, Pd, Pt, Ru, Rh, Ir) and cerium compounds containing the above transition metals and elements from IIIA-VIA groups of the Periodic Table. The necessary maintenance of the f-electron density localization, i.e. complete absence of overlapping between the wave functions of f-electrons of neighboring atoms, in heavy-fermion compounds is provided by the covalence degree in the range of 0.3-0.7 in the chemical bond of atoms in the strengthening layer and the band gap (ΔE) of 0<ΔE<3 eV between the valence band and the conduction band, which is equivalent to the distance of no less than 3.5-4 Å between 4f-electrons of neighboring atoms.

The thickness of the strengthening layer should be commensurable with the micro-crack sizes on the articles, and, as experiments show, it is determined by the necessity to fill the mouths of cracks. In the general case, the thickness of the layer can be 0.1-0.3 μm. The layer thickness of 0.1 μm provides the enhancement of the strength properties of the article by a factor of one order (no less than in ten times). In this case, the larger the layer thickness is at the formation of the layer at one step, the better the strength properties of the article are.

In addition, the strengthening layer, comprising a plurality of single layers, can be formed using several steps, one step for each such single layer. In this case, the single layers of the coating can be composed both of the same heavy-fermion material and of different heavy-fermion materials, each of which is responsible for the realization of a specific desirable property. Thus, for example, in order to improve exploitation properties of an article functioning in an aggressive medium in the regime of impulse action, the strengthening layer can consist of different materials, one of which would enhance the wear resistance of the article at impulse action and another would protect the article against the destructive action of the aggressive medium.

To increase the corrosion, erosion and oxidation resistance, after the strengthening layer deposition, it is practical to deposit a layer of crystalline material over the strengthening layer, which material readily turns into amorphous. Amorphization can happen during the layer deposition or as the result of external actions in the process of the article functioning (pressure, temperature, polishing). Protective properties of amorphous coating are associated with the presence of a strong covalent bond of the material atoms contained in the coating composition.

Materials, which can readily become amorphous, are the compounds of the above transition metals containing elements from IIIA-VIA groups of the Periodic Table, for example, such as Fe(Ni,Co)—X, where X is B, P and Si, or CeSi.

In general, the improvement of the wear resistance properties of articles are not associated with the use of a particular technology and with the choice of particular materials for the strengthening layer deposition. Based on the functioning conditions of the article, it is possible to select optimal materials for the strengthening layer. Thus, for example, for the articles operating in the regime of impulse action of large loadings, in the interval between the actions of the loadings upon the article (for example, during no-load operation), the relaxation time of the material electronic structure should be larger than the time the interval.

The electronic structure relaxation time is determined by the value of density of electron states at the Fermi level or by the effective mass of conduction electrons. These parameters can be measured with the help of the coefficient of electronic specific heat, γ. When the regime of operation and the processes taking place are known, the strengthening layer materials can be selected; thus, for example, at the impulse action with the interval of 10⁻⁴ s on parts of compressors and turbines of aircraft engines, the CeSi₂, CeSn₃ and CePt₃ compounds can be used as materials for the strengthening layer; at the action with 10⁻⁴ s interval, the Ce₃Pd₂Ge₅, CeCu₂Si₂ and CeRu₂Si₂ compounds can be used for the layer applied on cylinder rings of the internal combustion engines; for metal-processing tools undergoing the impulse action with an interval of 10⁻² s, CePd₃, CeCu₆, CeCu₃ can be used; for lathe bits, etc., which are under continuous loads, a strengthening layer from the cerium-palladium alloy (CePd₃) can be used, since the heavy-fermion state of the alloy is expected to exist for long after the external actions.

### PREFERRED EXEMPLARY EMBODIMENTS OF THE INVENTION

While the invention may be susceptible to embodiment in different forms, there are described in detail herein, specific embodiments of the present invention, with the understanding that the present disclosure is to be considered an exemplification of the principles of the invention, and is not intended to limit the invention to that as illustrated and described herein.

### Example 1

It is practical to use the CeCu₂Si₂ compound as a strengthening layer on the surface of compressor blades of an airplane engine, which is applied using the ion implantation method and is ˜0.1 μm in thickness. The service span of the blades increases by more than one order of magnitude.

The bench fatigue tests of serial (uncoated) and experimental (coated with the strengthening layer) blades carried out at the manufacturing plant show an increase in service span of the experimental blade by more than one order of magnitude at the same loading of 22 kg·f mm⁻² and the vibration frequency of 6.7 kHz. Six blades coated with the cerium compound (CeCu₂Si₂) did not fail neither after the first 10⁸ fatigue test cycles, nor after the second (2×10⁸) test cycles (see TABLE below), and during the third (3×10⁸) test cycles, the sensors mounted on the blades began to come off, however the blades remained undamaged. As known, the uncoated blades had been broken in the interval from 1.5×10⁷ to 5×10⁷ cycles.

The research was carried out by specialists of the Udmurt State University, Physical-Technical Institute UB RAS (Izhevsk), Kurchatovskiy Institute of Atomic Energy (Moscow) and Cooperative Association “Aviadvigatel” (Perm).

### Table

The results of the fatigue tests of the of the 3^{rd} degree
high-pressure compressor blades of the engine PS-90A
subjected to ion implantation and loading of 1 × 10⁸

| | σ, kg · f/mm² | | | |
|---|---|---|---|---|
| | according to | | | |
| Blade | the resistance | Frequency, | Time to failure | Fatigue |
| No | strain gauge | Hz | In cycles | test results |
| 20 | 22 | 6148 | 1 × 10⁸ | undamaged |
| 19 | 22 | 6137 | 1 × 10⁸ | undamaged |
| 18 | 22 | 6069 | 1 × 10⁸ | undamaged |
| 17 | 22 | 5955 | 1 × 10⁸ | undamaged |
| 16 | 22 | 5870 | 1 × 10⁸ | undamaged |
| 15 | 22 | 6055 | 1 × 10⁸ | undamaged |
| 14 | 22 | 6143 | 1 × 10⁸ | undamaged |

The results of fatigue tests of the of the 3^{rd} degree
high-pressure compressor blades of the engine PS-90A
subjected to ion implantation and loading of 2 × 10⁸

| | σ, kg · f/mm² | | | |
|---|---|---|---|---|
| | according to | | | |
| Blade | the resistance | Frequency, | Time to failure | Fatigue |
| No | strain gauge | Hz | In cycles | test results |
| 14 | 22 | 6137 | 2 × 10⁸ | undamaged |
| 15 | 22 | 6055 | 2 × 10⁸ | undamaged |
| 16 | 22 | 5870 | 2 × 10⁸ | undamaged |
| 17 | 22 | 5955 | 2 × 10⁸ | undamaged |
| 18 | 22 | 6069 | 2 × 10⁸ | undamaged |
| 19 | 22 | 6137 | 2 × 10⁸ | undamaged |
| 20 | 22 | 6148 | 2 × 10⁸ | undamaged |

### Example 2

To impart improved wear resistance properties to a milling cutter, the CeAl₃ or CeCu₆ compound is used; the complete strengthening layer is formed by the method of laser-induced or electron-beam evaporation. The strengthening layer is applied layer-by-layer with each single layer thickness of about 0.1 μm and an interval of from 1-to 2 min until the complete layer thickness becomes 0.1-0.3 μm.

Then, a monolayer, or a multilayer coating of 0.1-0.3 μm in thickness is formed of an amorphized material, which readily becomes amorphous, using the base material of the article itself or the Fe₈₀P₁₃C₇ compound. As a result, the wear resistance of the article increases from ten to seventeen times compared to that of an uncoated article. The milling cutter thus coated is corrosion-resistant during its functioning.

### Example 3

It is practical to use the CeAl₃ compound for coating a submachine gun barrel surface with a strengthening layer. The strengthening layer is formed using the conventional electroplating method under standard conditions. The strengthening layer is applied layer-by-layer with each single layer thickness of about 0.1 μm and the interval of 1-2 min until the complete layer thickness becomes 0.1-0.3 μm. The material, the barrel is made of, is used as an amorphized material, which is sprayed over the strengthening layer. The wear resistance properties of the barrel improve by more than one order of magnitude.

Thus, the method offered allows to improve wear resistance properties of metal articles and parts by a factor of tens.

1. A method for improving wear resistance of a metal article comprising formation of a strengthening layer from at least one cerium heavy-fermion compound on the surface of said article.

2. The method according to claim 1, wherein said cerium heavy-fermion compound being a compound having a covalence degree of atomic chemical bond in the range from 0.3 to 0.7, and an energy gap of 0<ΔE<3 eV.

3. The method according to claim 1, wherein the cerium heavy-fermion compound being a compound containing, at least one element from IIIA-VIA groups of the Periodic Table, and/or at least one transition metal with a filled d-shell or a d-shell close to being filled.

4. The method according to claim 3, wherein said compound containing, at least one element from IIIA-VIA groups of the Periodic Table and/or at least one transition metal with a filled d-shell or a d-shell close to being filled, represented by any of the following compounds: Ce₃Pd₂Ge₅, and/or CeCu₂Si₂, and/or CeRu₂Si₂.

5. The method according to claim 3, wherein said compound containing, at least one element from IIIA-VIA groups of the Periodic Table and/or at least one transition metal with a filled d-shell or a d-shell close to being filled, represented by any of the following compounds: CeSi₂ and/or CeSn₃, and/or CePt₃.

6. The method according to claim 3, wherein said compound containing, at least one element from IIIA-VIA groups of the Periodic Table and/or at least one transition metal with a filled d-shell or a d-shell close to being filled, represented by any of the following compounds: CePd₃, and/or CeCu₆, and/or CeCu₃.

7. The method according to claim 1, wherein the strengthening layer formed of a plurality of single layers in several steps, each said single layer composed of the same heavy-fermion material or of different heavy-fermion materials.

8. The method according to claim 1, wherein after said metal article is coated with the strengthening layer, a layer of a crystalline material, which readily becomes amorphous, is applied over the strengthening layer.
